(19) United States
(12) Patent Application Publication
(10) Pub. No.: US 2026/0116492 A1
(43) Pub. Date: Apr. 30, 2026

(54) Suspension Linkage Apparatus and Method

(71) Applicant: Zhehan Wen, San Diego, CA (US)

(72) Inventor: Zhehan Wen, San Diego, CA (US)

(73) Assignee: Zhehan Wen, San Diego, CA (US)

(21) Appl. No.: 18/932,541

(22) Filed: Oct. 30, 2024

(51) Int. Cl. B62K 25/28; B62K 3/02

(52) U.S. Cl. CPC B62K 25/286; B62K 3/02

(57) ABSTRACT

A suspension system includes a front frame, a rear frame, a shock absorber and a first link. The front frame includes a first connection node and a second connection node. The rear frame includes a first connection node and a second connection node. The vehicle frame includes a third connection node and a fourth connection node. The first end of the shock absorber is connected to the first connection node, the second end of the shock absorber is connected to the third connection node, and the two ends of the first connecting rod are pivoted respectively. Connected to the second connection node and the fourth connection node, the first link is at least used to provide relative displacement in the front-rear direction for the front frame and the rear frame.

### BACKGROUND

In pedal cycles such as mountain bikes, the suspension system is an important component and largely determines the comfort of the rider. Generally speaking, the suspension system includes a front frame, a rear frame, a shock absorber and other structures. When the bicycle is pedaled to accelerate, braked to decelerate or impacted, the front body and the rear body rotate relative to each other and the shock absorber is compressed or stretched, thereby achieving a dynamic buffering effect.

### SUMMARY

The present disclosure relates generally to the field of pedal cycle technologies, and specifically relates to a suspension system and a bicycle.

The present disclosure provides a suspension system and a bicycle, which can optimize the relative movement between the front frame and the rear frame, improve the impact absorption capacity of the suspension system, and improve riding comfort.

In order to solve the above technical problems, various embodiments of the present disclosure are implemented as follows.
In a first aspect, the embodiment of the present disclosure proposes a front frame, the front frame includes a first connection node and a second connection node;
Rear frame, the rear frame includes a third connection node and a fourth connection node;
Shock absorber, the first end of the shock absorber is connected to the first connection node, and the second end of the shock absorber is connected to the third connection node;
First connecting rod, the two ends of the first connecting rod are respectively pivoted to the second connection node and the fourth connection node, and the first connecting rod is at least used to provide relative displacement in the front and rear directions for the front frame and the a frame.

In the second aspect, the embodiment of the present disclosure proposes a bicycle, including the suspension system shown in the first aspect.

The suspension system provided in the embodiment of the present disclosure includes a front frame, a rear frame, a shock absorber and a first connecting rod, the front frame includes a first connecting node and a second connecting node, the rear frame includes a third connecting node and a fourth connecting node, the first end of the shock absorber is connected to the first connecting node, the second end of the shock absorber is connected to the third connecting node, the two ends of the first connecting rod are respectively pivoted to the second connecting node and the fourth connecting node, and the first connecting rod is at least used to provide the front frame and the rear frame with relative displacement in the front-to-back direction. The suspension system provided in the embodiment of the present disclosure, based on the relative displacement capability of the front frame and the rear frame in the front-to-back direction provided by the first connecting rod, enables the suspension system to respond to and absorb impacts in the front-to-back direction and other directions in a timely and effective manner, thereby improving riding stability and comfort.

Additional aspects and advantages of the present disclosure will be partially given in the following description, and some will become apparent from the following description, or will be understood through the practice of the present disclosure.

### BRIEF DESCRIPTION OF THE DRAWINGS

The above and/or additional aspects and advantages of the present disclosure will become apparent and easy to understand from the description of the embodiments in combination with the following drawings, in which:

FIG. 1 is a schematic diagram of the structure of the suspension system in the released state provided by the embodiment of the present disclosure;

FIG. 2 is a schematic diagram of the structure of the suspension system in the contracted state provided by the embodiment of the present disclosure;

FIG. 3 is a comparison diagram of the suspension system in the released state and the contracted state provided by the embodiment of the present disclosure;

FIG. 4 is a cross-sectional schematic diagram of the idler mechanism and its assembly structure;

FIG. 5 is an exploded schematic diagram of the idler mechanism and its assembly structure;

FIG. 6A is a schematic diagram of the cross-sectional shape of the first arm segment;

FIG. 6B is a schematic diagram of the cross-sectional shape of the second arm segment;

FIG. 7 is an exploded schematic diagram of the shock-absorbing connection mechanism and its assembly structure;

FIG. 8 is a schematic diagram of the three-dimensional structure of the bicycle provided by the embodiment of the present disclosure;

FIG. 9 is an example diagram for determining bicycle performance parameters when the suspension system is released;

FIG. 10 is an example diagram for determining bicycle performance parameters when the suspension system is compressed;

FIG. 11 is an example diagram for the simulation effect of the suspension system;

FIG. 12 is a diagram showing the relationship between chain growth and wheel travel;

FIG. 13 is a diagram showing the relationship between undamped natural frequency and wheel travel;

FIG. 14 is a diagram showing the relationship between chain line and instantaneous center offset relative to wheel travel

FIG. 15 is a diagram showing the relationship between suspension system lever ratio and wheel travel;

FIG. 16 is a diagram showing the relationship between pedal rebound and wheel travel;

FIG. 17 is a diagram depicting anti-rise behavior relative to wheel travel;

FIG. 18 is a diagram depicting anti-squat behavior relative to wheel travel; and

FIG. 19 is a diagram showing the axle path magnified when the rear wheel moves during the travel of the suspension system.

### NUMERAL REFERENCES IN THE DRAWINGS

100—front frame, 101—first connection node, 102—second connection node, 103—eighth connection node, 110—additional accessory mounting portion, 120—center tube, 121—mechanical interface, 130—first bracket arm, 131—first arm section, 1311—first web, 1312—first flange plate, 1313—first fillet transition portion, 140—second bracket arm, 141—second arm section, 1411—second web, 1412—second flange plate, 1413—second fillet transition portion, 150—reinforcement rib, 160—recessed platform, 170—crank mounting portion, 200—rear frame, 201—third connection node, 202—fourth connection node, 210—third bracket arm, 220—fourth bracket arm, 230—fifth bracket arm, 240—rear wheel mounting portion, 250—extension frame, 310—shock absorber, 320—shock absorber connecting mechanism, 321—connecting plate, 322—first pin, 323—second pin, 324—first screw, 325—second screw, 400—first connecting rod, 410—third arm segment, 420—fourth arm segment, 500—second connecting rod, 501—fifth connecting node, 502—sixth connecting node, 503—seventh connecting node, 600—idler mechanism, 610—idler body, 620—chain stabilizer, 621—limiting space, 630—pin, 640—target pivot axis, 641—second bearing, 651—first bearing, 652—bearing retainer, 811—rear gear set, 812—crank gear set, 821—crank, 822—pedal, 908—rear wheel, 909—front wheel, 913—rear axle.

### DETAILED DESCRIPTION

The embodiments of the present disclosure will be described in detail below. Examples of the embodiments are shown in the accompanying drawings, where the same or similar reference numerals throughout represent the same or similar elements or elements with the same or similar functions. The embodiments described below with reference to the accompanying drawings are exemplary and are only used to explain the present disclosure and cannot be understood as limiting the present disclosure. Based on the embodiments in the present disclosure, all other embodiments obtained by ordinary technicians in the field without creative work are within the scope of protection of the present disclosure.

The features of the terms “first” and “second” in the specification and claims of the present disclosure may explicitly or implicitly include one or more of the features. In the description of the present disclosure, unless otherwise specified, “multiple” means two or more. In addition, “and/or” in the specification and claims represents at least one of the connected objects, and the character “/” generally indicates that the objects associated before and after are in an “or”relationship.

In the description of this application, it should be understood that the terms “center”, “longitudinal”, “lateral”, “length”, “width”, “thickness”, “up”, “down”, “front”, “back”, “left”, “right”, “vertical”, “horizontal”, “top”, “bottom”, “inside”, “outside”, “clockwise”, “counterclockwise”, “axial”, “radial”, “circumferential” and the like indicate positions or positional relationships based on the positions or positional relationships shown in the drawings, and are only for the convenience of describing this application and simplifying the description, rather than indicating or implying that the device or element referred to must have a specific orientation, be constructed and operated in a specific orientation, and therefore cannot be understood as a limitation on this application.

In the description of this application, it should be noted that, unless otherwise clearly specified and limited, the terms “installed”, “connected” and “coupled” should be understood in a broad sense, for example, it can be a fixed connection, a detachable connection, or an integral connection; it can be a mechanical connection or an electrical connection; it can be a direct connection, or it can be an indirect connection through an intermediate medium, or it can be a connection between the two elements. For ordinary technicians in this field, the specific meanings of the above terms in this application can be understood according to specific circumstances.

Although in the following descriptions of various embodiments of the present disclosure, a bicycle is used as an example, those of ordinary skill in the art will recognize that various embodiments of the present disclosure can be applied to other vehicles and pedal cycles, such as unicycles, tricycles, quadricycles, etc.

For example, a full-suspension mountain bike or other bicycle is provided with a suspension system, which generally includes a front frame, a rear frame and a shock absorber, and the front frame and the rear frame respectively have corresponding wheel nodes. There are generally two main connection nodes between the front frame and the rear frame, including: a first connection node for pivoting between the front frame and the rear frame, and a second connection node for indirect connection through the shock absorber. When the bicycle is pedaled to accelerate, braked to decelerate, or impacted, the front frame and the rear frame rotate relative to each other at the first connection node, and the shock absorber is driven to move in the shock absorption direction at the second connection node, thereby realizing the shock absorption function.

In many implementations of suspension systems, the relative movement of certain market design between the front frame and the rear frame is limited, and the suspension system is difficult to effectively absorb the impact due to inefficient leverage, resulting in low comfort. Additionally, existing market designs have various issues that deteriorate the riding experience, including pedal kick-back, pedaling inefficiency, and suspension compression interference during braking.

In some implementations, the front frame and the rear frame are usually directly pivoted at the first connection node. In the scenario of pedaling acceleration, braking deceleration, or impact, the front frame and the rear frame drive the shock absorber located at the second connection node through a single rotational motion to achieve shock absorption. In some scenarios, such as when the rear wheel of a bicycle encounters an obstacle, this structure based on a single rotational motion between the frames to drive the shock absorber will cause a large pitch change in the suspension system, affecting the riding comfort of the rider. On the other hand, there is a large angle between the force direction of the rear wheel obstacle on the bicycle and the relative rotation direction of the front frame and the rear frame. The impact from the rear wheel obstacle is difficult to effectively act on the shock absorber, which makes it difficult to absorb the impact and causes a large attenuation of the power of the bicycle.

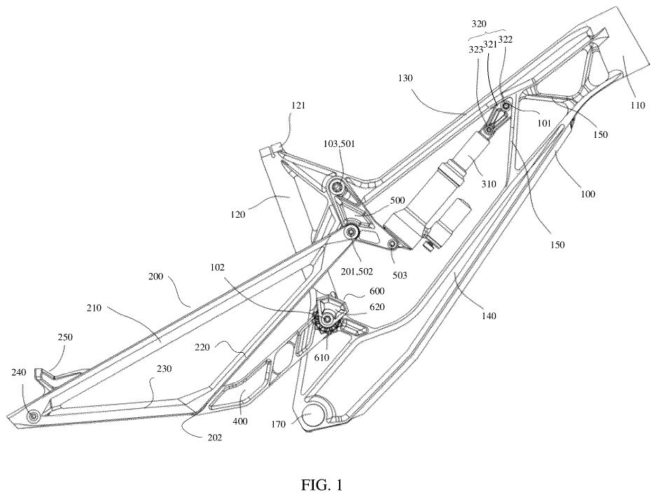

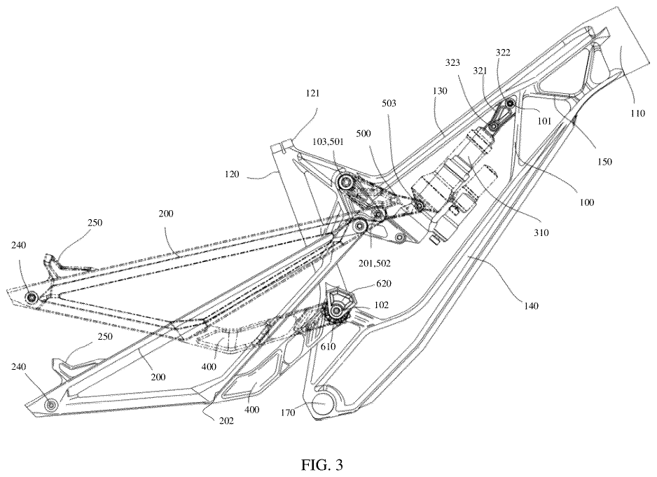

In order to solve the problems existing in some implementations, the embodiments of the present disclosure provide a suspension system. As shown in FIGS. 1 to 3, the suspension system according to some embodiments of the present disclosure includes a front frame 100, a rear frame 200, a shock absorber 310 and a first connecting rod 400.

The front frame 100 includes a first connection node 101 and a second connection node 102, the rear frame 200 includes a third connection node 201 and a fourth connection node 202, the first end of the shock absorber is connected to a node at 323 which is linked to the first connection node by a rack 321 that is fastened by a bolt 322 at the first connection node, the second end of the shock absorber 310 is connected to the third connection node 201, the two ends of the first connecting rod 400 are respectively pivoted to the second connection node 102 and the fourth connection node 202, and the first connecting rod 400 is at least used to provide the front frame 100 and the rear frame 200 with relative displacement in the front-back direction.

The above description of the connection nodes such as the first connection node 101 and the second connection node 102 may be a structure that can be used for direct connection, such as an opening for pivoting, a rotating shaft or a threaded hole matching the opening, etc. The connection node may include an auxiliary structure for connection, such as a bearing or a pin, etc. Alternatively, the connection node may also be a general term for multiple components, which can be used to achieve an indirect connection between two features, such as a lever, a connecting rod or other types of transmission mechanisms. Of course, some connection nodes can also be a reference to the boundary between different components without specific connectors, such as the connection between multiple integrally formed bracket arms.

The shock absorber 310 can be a spring shock absorber, a gas pressure shock absorber, an oil pressure shock absorber, or a combination of multiple forms of shock absorbers, etc., and can be selected and set according to actual needs, and the embodiment of the present disclosure is not specifically limited. The shock absorber 310 can provide a suspension travel for the suspension system. When subjected to external force, the shock absorber 310 can produce a length change in the shock absorption direction. For ease of description, in the embodiment of the present disclosure, the shock absorber 310 is defined as switching between the release state and the compression state. In the release state, the shock absorber 310 is in a natural extension state, and when subjected to external impact, the shock absorber 310 is compressed and enters a compression state. Similarly, the suspension system can be defined as switching between the release state and the compression state, and the state of the suspension system corresponds to the state of the shock absorber 310.

In some possible implementations, the shock absorber 310 can also absorb external impacts by stretching, and these implementations will not be described in detail.

In the embodiment of the present disclosure, there are two main connection relationships between the front frame 100 and the rear frame 200 of the suspension system,

one is connected to the shock absorber 310 through the connecting rod 500 and the other is connected through the first connecting rod 400. In the case where the front frame 100 is used as a static reference object, based on the connection relationship definition of each connection node, the shock absorber 310, the rear frame 200 and the first connecting rod 400 form a sequentially connected structure. When the rear frame 200 moves due to factors such as external impact, the first connecting rod 400 and the shock absorber 310 will be linked. From the perspective of the shock absorber 310, it can respond to the movement of the rear frame 200, generate displacement in the shock absorption direction, and absorb external impact. From the perspective of the first connecting rod 400, during its movement, it will cause the rear frame 200 to generate displacement relative to the front frame 100 in the front-to-back direction.

Based on the description of the linkage relationship between the above components, in some scenarios where the suspension system is impacted, for example, when the rear wheel connected to the rear frame 200 encounters an obstacle, the rear frame 200 is subjected to a backward impact force, and the rear frame 200 tends to rotate and move upwards relative to the front frame 100, and the impact force causes the first link 400 to pivot relative to the second connection node 102 to adapt to the movement trend of the rear frame 200. Through the linkage between the shock absorber 310, the rear frame 200 and the first link 400, the shock absorber 310 can move in the shock absorption direction, thereby effectively transmitting the impact force to the shock absorber 310, allowing the suspension system to effectively absorb the impact.

In other scenarios, such as conventional scenarios such as pedaling acceleration, braking deceleration, through the linkage between the rear frame 200 and the first link 400, the rear frame 200 can also produce a movement form similar to pivoting relative to the front frame 100, which can produce a shock absorption effect similar to the existing structure of the rear frame 200 and the front frame 100 directly pivoting.

Compared with the existing structure of the rear frame 200 and the front frame 100 directly pivoting, the suspension system provided in the embodiment of the present disclosure can not only retain the shock absorption ability of the existing structure in some conventional scenarios, but also effectively absorb the front and rear impact in scenarios such as the rear wheel encountering obstacles, thereby greatly improving the riding comfort of the rider.

In addition, based on the relative displacement ability of the front frame 100 and the rear frame 200 in the front and rear directions provided by the first link 400, the suspension system can respond to the impact in the front and rear directions in a timely and effective manner, reduce the power attenuation caused by the impact, and improve the riding efficiency.

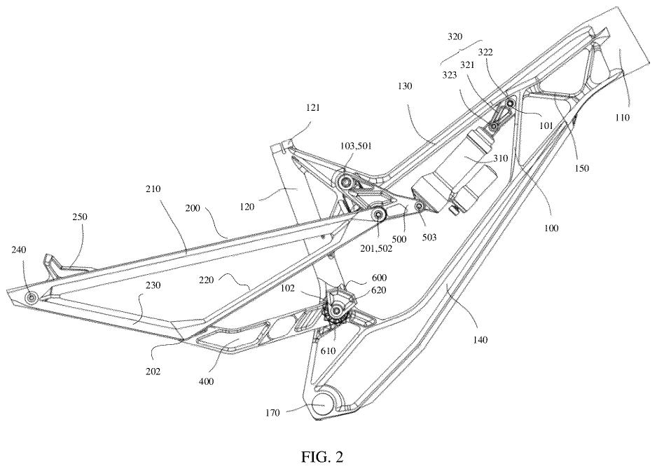

Referring to FIG. 1 and FIG. 2, FIG. 1 exemplarily shows a schematic diagram of the structure of the suspension system in a released state, and FIG. 2 exemplarily shows a schematic diagram of the structure of the suspension system in a compressed state. It can be seen that in the process of the suspension system switching from the released state to the compressed state, the end of the first link 400 pivoted at the fourth connection node 202 produces a large rearward displacement relative to the front frame 100. In the scenario where the rear wheel encounters an obstacle, the rear frame 200 can produce a relatively obvious rearward movement relative to the front frame 100, and effectively transmit the movement and impact to the shock absorber 310, thereby allowing the suspension system to effectively absorb the impact and improve riding stability and comfort.

Similarly, the front frame 100 is used as a static reference object. Generally speaking, when the rear frame 200 moves to any position due to impact, the rear frame 200, the shock absorber 310 and the first link 400 should have a unique configuration so that the movement of the rear frame 200 follows a predetermined path, ensuring a controlled wheel travel or equivalent component movement, while ensuring the reliability of the overall structure of the suspension system. The following examples illustrate some feasible structures for ensuring the uniqueness of the configuration.

The rear frame 200 and the first connecting rod 400 are rigid or substantially rigid structures, and the two can form a two-link mechanism. For the shock absorber 310, it has a degree of freedom of movement in the shock absorption direction, that is, the overall length will change due to external force.

In one embodiment, the first connection node 101 of the front frame 100 can be fixedly connected, and the shock absorber 310 can produce linear motion in the shock absorption direction relative to the front frame 100, but cannot rotate relative to the front frame 100. At this time, the shock absorber 310 can be equivalent to a slider, and when the second end of the shock absorber 310 is pivotally connected to the third connection node 201 of the rear frame 200, the rear frame 200, the first connecting rod 400 and the shock absorber 310 can be equivalent to a crank slider. In this way, when the rear frame 200 moves to any position, the suspension system can ensure a unique configuration.

In another embodiment, an intermediate connecting member may be provided, which is pivotally connected to the front frame 100 and forms a three-link mechanism together with the rear frame 200 and the first connecting rod 400. When both ends of the three-link mechanism are pivotally connected to the front frame 100, the three-link mechanism may have a unique configuration when the rear frame 200 moves. At the same time, the first and second ends of the shock absorber 310 may be pivotally connected to the first connection node 101 and the intermediate connecting member, respectively, and a triangular layout is formed between the shock absorber 310, the intermediate connecting member and the front frame 100, and a basically unique configuration is generated as the length of the shock absorber 310 changes. When the rear frame 200 moves to any position, the three-link mechanism can generate a unique configuration, and the shock absorber 310 configuration can be unique through the intermediate connecting member, so that the overall suspension system can basically guarantee a unique configuration.

The above are examples of some feasible implementation methods for ensuring a unique configuration of the suspension system. In practical applications, the structure of the suspension system can also be designed as needed, and examples are not given here one by one.

As shown in FIGS. 1 to 3, in some embodiments, the suspension system also includes a second connecting rod 500, the second connecting rod 500 includes a fifth connecting node 501, a sixth connecting node 502 and a seventh connecting node 503, and the front frame 100 also includes an eighth connecting node 103;

The fifth connecting node 501 is pivoted to the eighth connecting node 103, the sixth connecting node 502 is pivoted to the third connecting node 201, and the seventh connecting node 503 is pivoted to the second end of the shock absorber 310.

In this embodiment, the second connecting rod 500 can be the intermediate connecting member corresponding to the above, which includes at least three connecting nodes for pivoting, namely the fifth connecting node 501, the sixth connecting node 502 and the seventh connecting node 503. In terms of connection relationship, the sixth connection node 502 is pivoted to the third connection node 201, and the seventh connection node 503 is pivoted to the second end of the shock absorber 310, so that the second end of the shock absorber 310 is indirectly connected to the third connection node 201.

Combined with the above description of the implementation of the intermediate connecting member, in this embodiment, the first connecting rod 400, the rear frame 200 and the second connecting rod 500 are pivoted in sequence to form a four-link mechanism, which is pivoted to the front frame 100 at the head and tail. When the rear frame 200 moves to any position, the four-link mechanism has a corresponding unique configuration. At the same time, the second connecting rod 500, the shock absorber 310 and the front frame 100 can be pivoted in pairs. Through the change in the length of the shock absorber 310 in the shock absorbing direction, when the second connecting rod 500 reaches any position based on the linkage of the three-link mechanism, the shock absorber 310 also has a corresponding unique configuration. In this way, the suspension system of this embodiment has a unique or substantially unique configuration between each component in each state, avoiding uncontrolled relative movement between each component, thereby helping to ensure the working reliability and stability of the suspension system.

As shown in FIGS. 1 and 2, in some embodiments, the fifth connection node 501, the sixth connection node 502, and the seventh connection node 503 are distributed in a triangular shape.

In some scenarios, such as when riding in complex terrain, the second link 500 may need to frequently transmit the impact from the rear frame 200. In this embodiment, the three connection nodes in the second link 500 are distributed in a triangular shape, which helps to improve the reliability of the overall structure of the second link 500, better cope with the transmission of impact, and improve the service life.

In some embodiments, the second link 500 can adapt to the triangular distribution of the connection nodes and is also designed as a triangular plate structure, for example, it can be an isosceles triangle plate structure. At the same time, the second link 500 is designed to be hollowed out, while improving the structural reliability of the second link 500, avoiding excessive weight increase to the suspension system.

As some feasible implementations, the fifth connection node 501, the sixth connection node 502 and the seventh connection node 503 may also be distributed on the same straight line.

In some implementations, the second connecting rod 500 may be used as a lever to amplify or attenuate the force transmitted from the rear frame 200 to the shock absorber 310. Among them, the fifth connecting node 501 can be considered as the fulcrum of the lever, the first straight line length from the fifth connecting node 501 to the sixth connecting node 502 affects the first force arm of the first force from the rear frame 200, and the second straight line length from the fifth connecting node 501 to the seventh connecting node 503 affects the second force arm of the second force from the shock absorber 310. By reasonably designing the first straight line length and the second straight line length, the second connecting rod 500 can obtain the desired lever effect.

In some embodiments, the first straight line length from the fifth connecting node 501 to the sixth connecting node 502 is less than the second straight line length from the fifth connecting node 501 to the seventh connecting node 503.

It is easy to understand that the first force arm and the second force arm are not only affected by the first straight line length and the second straight line length, but also by the direction of the first force and the second force. During the pivoting of the rear frame 200 and the shock absorber 310 relative to the second link 500, the directions of the first force and the second force change, which also results in that when the first straight length and the second straight length are fixed, the first force arm and the second force arm continuously change with the movement of the shock absorber 310. Of course, by designing the layout of the rear frame 200, the second link 500 and the shock absorber 310, the ratio of the first force arm to the second force arm can be controlled within a certain range.

In this embodiment, the length of the first straight line is designed to be less than the length of the second straight line, which can provide a good structural basis for attenuating the force transmitted from the rear frame 200 to the shock absorber 310, thereby helping to avoid excessive impact force at the shock absorber 310, thereby helping to protect the shock absorber 310 and increase the service life of the shock absorber 310.

In some embodiments, the length of the third straight line between the second connection node 102 and the fourth connection node 202 is greater than or equal to the length threshold, and the length of the fourth straight line between the fifth connection node 501 and the sixth connection node 502 is less than or equal to a preset percentage of the third straight line length.

In another embodiment, the direct distance between connecting rod 102 and connecting rod 202 is greater than the distance between the rear wheel mounting portion 240 and connecting rod 202.

In some examples, the length threshold can be 200 mm or other values to ensure that there is sufficient length between the two end pivot points of the first link 400. The preset percentage is less than 100%, and in one example, the preset percentage is 50%. Through the design of the above-mentioned length dimension relationship, during the compression process of the suspension system, the first link 400 itself has a small inclination change, and at the same time, the inclination change of the second link 500 can be amplified to facilitate the sufficient transmission of the impact to the shock absorber 310.

As shown in FIG. 1 and FIG. 2, in some embodiments, the suspension system further includes an idler mechanism 600, and the idler mechanism 600 is connected to the front frame 100.

In this embodiment, an idler mechanism 600 is arranged on the front frame 100. Generally speaking, the idler mechanism 600 can be arranged on the transmission path of the bicycle chain. Through reasonable position setting, the idler mechanism 600 can achieve corresponding functions.

In some examples, the idler mechanism 600 can be used to increase the chain transmission distance, which is convenient for optimizing the layout of the bicycle chain transmission system. Alternatively, the idler mechanism 600 can be used to adjust the pressure angle of the chain on the sprocket to improve the transmission performance and efficiency. Alternatively, the idler mechanism 600 can also be used to prevent the chain or equivalent connecting rod from extending in length when the suspension system is in a compressed state, to maintain consistent tension on the chain and prevent undesirable mechanical feedback or crank rotation, thereby improving the efficiency of the transmission system and maintaining smooth power transmission.

As shown in FIG. 1 and FIG. 2, the arrangement and function realization of the idler mechanism 600 are described in detail in combination with some specific embodiments below.

In some embodiments, the front frame 100 further includes a crank mounting portion 170, the crank mounting portion 170 and the idler mechanism 600 are relatively fixed in position, and the crank mounting portion 170 is located below the idler mechanism 600.

The crank mounting portion 170 can be used for mounting a bicycle crank. In some examples, the crank mounting portion 170 can be an opening provided on the front frame 100. As for other accessories used for crank mounting in the crank mounting portion 170, such as bearings, etc., they are not described in detail here.

The crank mounting portion 170 is located below the idler mechanism 600, which mainly refers to the relative relationship between the crank mounting portion 170 and the idler mechanism 600 when the suspension system stands on a horizontal plane. In the following embodiments, unless otherwise specified, the up-down and down-down orientation relationships between the components can be considered as the orientation relationships obtained when the suspension system stands on a horizontal plane.

In this embodiment, the crank mounting portion 170 is fixed on the front frame 100, and the idler mechanism 600 is mounted on the front frame 100, and the relative position with respect to the front frame 100 can also be fixed. In this way, the relative position of the crank mounting portion 170 and the idler mechanism 600 can also be fixed.

Generally speaking, the crank and the front sprocket in the bicycle are coaxially connected, and the chain transmission path passes through the front chain link and the idler mechanism 600. When the relative position of the crank mounting portion 170 and the idler mechanism 600 is fixed, the length of the portion of the chain between the front sprocket and the idler mechanism 600 is also basically fixed. To simplify the description, the portion of the chain between the front sprocket and the idler mechanism 600 can be referred to as the first chain segment, and the portion of the chain between the idler mechanism 600 and the rear chain link can be referred to as the second chain segment. The length of the first chain segment accounts for a relatively small proportion of the entire chain, and because the crank mounting portion 170 and the idler mechanism 600 are arranged up and down, the first chain segment mainly extends in the up and down direction, is less affected by external impact, and has a smaller length change. At the same time, the idler mechanism 600 can decouple the motion of the first chain segment and the second chain segment that is prone to length change to a certain extent. Under the influence of the above factors, when the suspension system is subjected to external impact, the force exerted by the first sprocket on the front sprocket is small, which can effectively reduce the reversal of the crank and the rebound of the pedal, thereby improving the efficiency of the chain transmission system and maintaining smooth power transmission, thereby improving the comfort of the rider.

As shown in FIGS. 1 and 2, in some embodiments, the rear frame 200 also includes a rear wheel mounting portion 240, and when the shock absorber 310 is in a released state, the rear wheel mounting portion 240 is located below the idler mechanism 600.

The rear wheel mounting portion 240 is used to mount the rear wheel of the bicycle. Similar to the crank mounting portion 170 mentioned above, the rear wheel mounting portion 240 can also be an opening arranged on the rear frame 200. As for the detailed assembly method of the rear wheel and the rear sprocket and other structures on the rear wheel mounting portion 240, it is not described in detail here. In this embodiment, when the suspension system stands on a horizontal plane and is in a released state, the idler mechanism 600 is located above the rear wheel mounting portion 240, that is, the position of the idler mechanism 600 is higher than the axle of the rear wheel or its equivalent rotating component.

Borrowing the definition of the second chain segment in the previous embodiment, generally speaking, the second chain segment has a relatively long length and mainly extends in the front-to-back direction. When the suspension system is impacted, the front frame 100 and the rear frame 200 move relative to each other, so that the distance between the idler mechanism 600 on the front frame 100 and the rear chain link on the rear frame 200 may change greatly, which may also cause the second chain segment to face a large tensile force, which is transmitted to the front sprocket through the chain, and may cause the crank to reverse and the pedal to rebound.

In this embodiment, the relative height of the rear wheel mounting portion 240 and the idler mechanism 600 is designed. Referring to FIG. 1, when the shock absorber 310 is in the released state, the rear wheel mounting portion 240 is located below the idler mechanism 600; referring to FIG. 2, when the shock absorber 310 switches from the released state to the compressed state, the rear wheel mounting portion 240 will move closer to the idler mechanism 600, and the distance between the rear wheel mounting portion 240 and the idler mechanism 600 will be shortened. The effect of shortening the distance will further shorten the upper length of the chain, thereby preventing the crank from reversing and the pedal from rebounding.

Based on the above embodiments, it can be seen that the setting of the idler mechanism 600 helps to ensure the performance of the chain transmission system, and at the same time, it is crucial for the suspension system to effectively cope with terrain impact. The following describes some specific implementation structures of the idler mechanism 600.

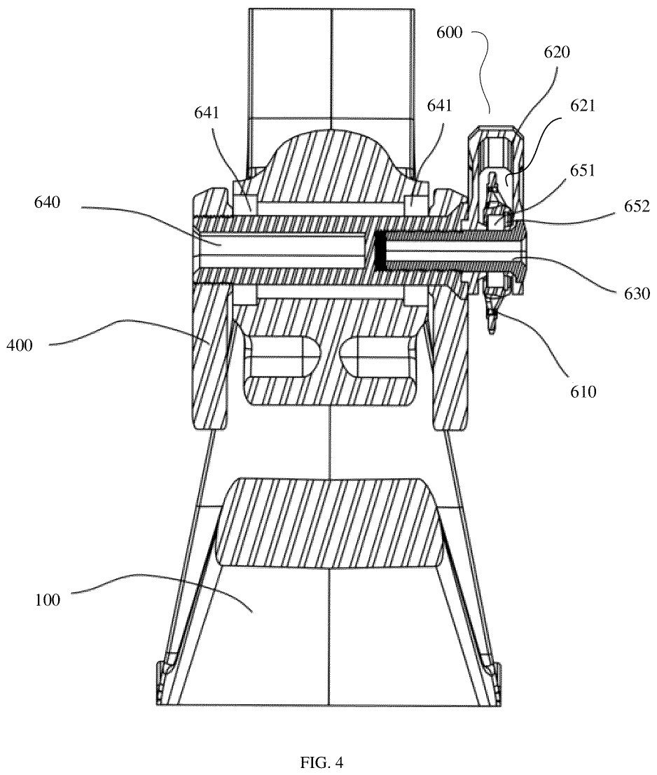

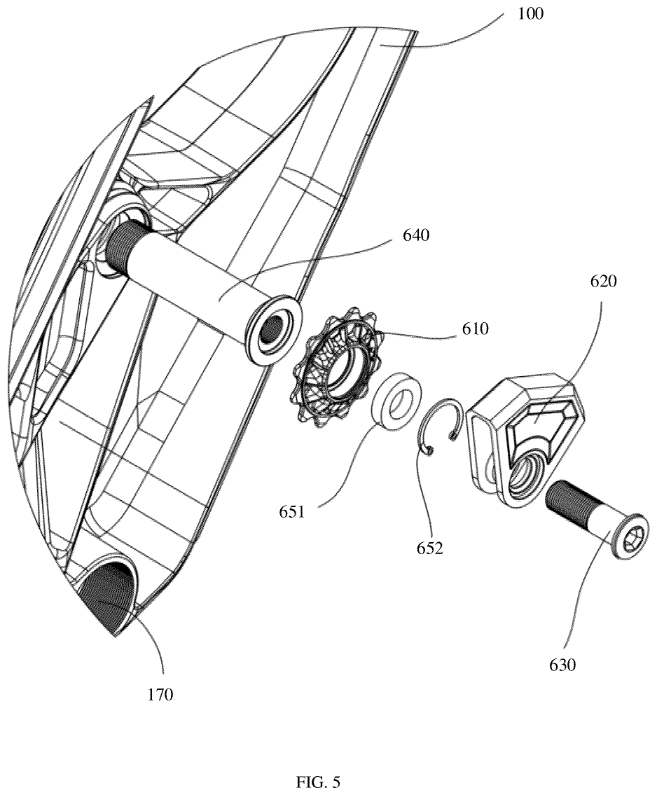

As shown in FIGS. 4 and 5, in some embodiments, the idler mechanism 600 includes an idler body 610 and a chain stabilizer 620. The idler body 610 is rotatably connected to the front frame 100, and the chain stabilizer 620 is straddled on the idler body 610 and enclosed with the idler body 610 to form a limited space 621.

Generally speaking, the idler body 610 is on the transmission path of the chain and rotates with the transmission of the chain. Accordingly, the idler body 610 can support the chain in a certain direction. When the chain stabilizer 620 is not configured, when the suspension system enters a compressed state, or when the chain rebounds due to impact, it may extend in the support direction of the idler body 610 or even detach from the idler body 610.

In this embodiment, the idler mechanism 600 may further include a chain stabilizer 620 straddling the idler body 610, and enclosing the idler body 610 to form a limiting space 621. The limiting space 621 allows the chain to pass in the transmission direction, and forms a limit on the chain in the direction of support of the idler body 610 for the chain, and in the direction perpendicular to the transmission direction and the support direction, so that the chain can be effectively prevented from coming off the idler body 610, thereby improving the reliability of the chain transmission system.

In some embodiments, the idler body 610 can be mounted on the front frame 100 through an independent support shaft. Alternatively, it can also be mounted on a pivot shaft at some connection nodes, thereby helping to reduce the difficulty of the layout of the structure on the front frame 100.

For example, as shown in FIG. 4 and FIG. 5, in one embodiment, the idler mechanism 600 further includes a pin 630, the first end of the pin 630 is embedded in the axial end opening of the target pivot shaft 640, and the chain stabilizer 620 is limited between the second end of the pin 630 and the axial end of the target pivot shaft 640 in the axial direction of the pin 630;

The target pivot shaft 640 is a pivot shaft for pivoting the second connection node 102 and the first link 400.

The target pivot shaft 640 can be used to provide pivoting freedom for the front frame 100 and the first link 400, and the target pivot shaft 640 can be fixed to one of the front frame 100 and the first link 400, and is rotationally connected to the other of the front frame 100 and the first link 400. Alternatively, the target pivot shaft 640 can also be rotationally connected to the front frame 100 and the first link 400 at the same time.

As shown in FIG. 4, in some examples, the target pivot shaft 640 can be assembled into an opening on the first link 400 by means of threads or interference fit, and can be rotatably connected to the front frame 100 via a second bearing 641.

An opening for embedding the pin 630 may be provided on the shaft end of the target pivot shaft 640. In some examples, the pin 630 may include a cylindrical portion with a circular cross section and a relatively small cross section and a tail portion with a relatively large cross section. The first end of the pin 630 may be the end where the cylindrical portion is located, which may be embedded in the shaft end opening of the target pivot shaft 640 by, for example, transition fit, interference fit, snap fit, or threaded connection.

The pin 630 has a tail portion with a larger cross section, which is arranged opposite to the shaft end of the target pivot shaft 640, and the two can form a limiting effect on the chain stabilizer 620 in the axial direction. At the same time, the relative displacement of the chain stability and the pin 630 in the radial direction can also be limited by a connection method such as nesting, so that the chain stabilizer 620 can be conveniently and reliably installed.

As shown in FIG. 4 and FIG. 5, in some embodiments, the idler mechanism 600 may further include a first bearing 651 and a bearing retainer 652, wherein the first bearing 651 is used to rotatably connect the idler body 610 to the pin 630, and the bearing retainer 652 is used to limit the relative movement between the first bearing 651 and the chain stabilizer 620 in the axial direction.

In some examples, the first bearing 651 may be a ball bearing, a roller bearing, or a self-lubricating bearing, etc. The first bearing 651 is provided so that the idler body 610 can rotate around the pin 630, thereby reducing the resistance to the chain transmission system.

At the same time, in this embodiment, a bearing retainer 652 may be provided between the first bearing 651 and the chain stabilizer 620, so that the first bearing 651 and the chain stabilizer 620 are relatively fixed in the axial direction, thereby preventing the first bearing 651 and the idler body 610 from generating undesirable movement in the axial direction, thereby helping to provide transmission stability of the chain transmission system. In some examples, the bearing retainer 652 may be an elastic gasket or a similar structure.

As shown in FIG. 1 and FIG. 2, in some embodiments, the front frame 100 includes: an additional accessory mounting portion 110, a first bracket arm 130, a second bracket arm 140, and a center tube 120. The first end of the first bracket arm 130 is fixedly connected to the additional accessory mounting portion 110, the second end of the first bracket arm 130 is fixedly connected to the center tube 120, the second end of the second bracket arm 140 is fixedly connected to the center tube 120, and the second bracket arm 140 is located below the first bracket arm 130.

In some embodiments, the additional accessory mounting portion 110 can be used to install a front fork and related structures, such as a front wheel, a handlebar, etc. The center tube 120 can be used to install a seat and related structures. For example, the center tube 120 can include a mechanical interface 121 located at the upper end for installing an adjustable seat, etc.

The first bracket arm 130 and the second bracket arm 140 may have high strength, and the fixed connection with the additional accessory mounting portion 110 and the central tube 120 makes the front frame 100 as a whole have good structural stability, and provides mounting portions for other necessary parts of the bicycle, which facilitates the overall assembly of the bicycle.

In some examples, any two of the first bracket arm 130, the second bracket arm 140, the additional accessory mounting portion 110 and the central tube 120 are in a fixed connection relationship, and the specific connection method may be welding or integral molding, etc.

In some embodiments, the front frame 100 further includes a reinforcing rib 150, which is located on a side close to the additional accessory mounting portion 110, and the reinforcing rib 150, the first bracket arm 130 and the second bracket arm 140 enclose at least one hollow area.

In the front frame 100, the first bracket arm 130 and the second bracket arm 140 may be arranged in an upper and lower relationship, and there may be a gap between the two. In this embodiment, a reinforcing rib 150 may be provided between the first bracket arm 130 and the second bracket arm 140 to further improve the overall structural reliability and stability of the front frame 100.

The number of reinforcing ribs 150 may be one or more, and these reinforcing ribs 150 may be enclosed with the first bracket arm 130 and the second bracket arm 140 to form at least one hollow area, so that excessive weight increase to the front frame 100 can be avoided.

The materials of the components of the front frame 100 may be the same or different. In some examples, the front frame 100 may be made of one or more materials selected from aluminum alloy, magnesium alloy, steel alloy, polymer material and carbon fiber composite material.

Generally speaking, the intermediate tube and the additional accessory mounting portion 110 may be tubular, and the shapes of the first bracket arm 130 and the second bracket arm 140 may be set as required, for example, they may be tubular, rod-shaped or profiled.

In some examples, the cross-section of the first support arm 130 and the second support arm 140 can be I-shaped, H-shaped or T-shaped, etc., with symmetrical depressions on the left and right sides, so that during the manufacturing process, the first support arm 130, the second support arm 140 or the entire front frame 100 can be manufactured at two symmetrical positions of the machine tool. At the same time, the structural design of the front frame 100 can ensure that each surface of the first support arm 130 and the second support arm 140 can be approached by the machine tool from different processing angles, and this accessibility supports the efficient manufacturing of the front frame 100.

In some embodiments, the first support arm 130 and the second support arm 140 are integrally cast.

In the front frame 100, the first support arm 130 and the second support part can be directly or indirectly connected. For example, the first support arm 130 and the second support arm 140 are connected to each other near the additional accessory mounting part 110. Alternatively, in combination with the above embodiment, the first support arm 130 and the second support arm 140 can also be indirectly connected through the reinforcing rib 150. In addition, as shown in the above embodiments, the first support arm 130 and the second support arm 140 can adopt a cross-sectional shape such as an I-shaped or H-shaped.

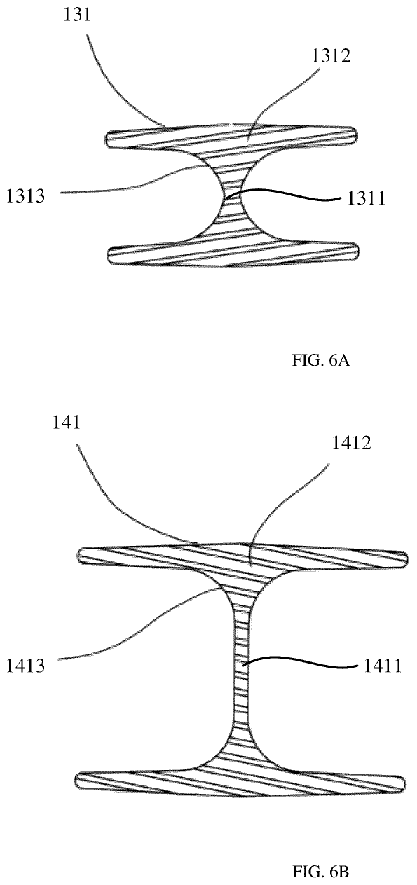

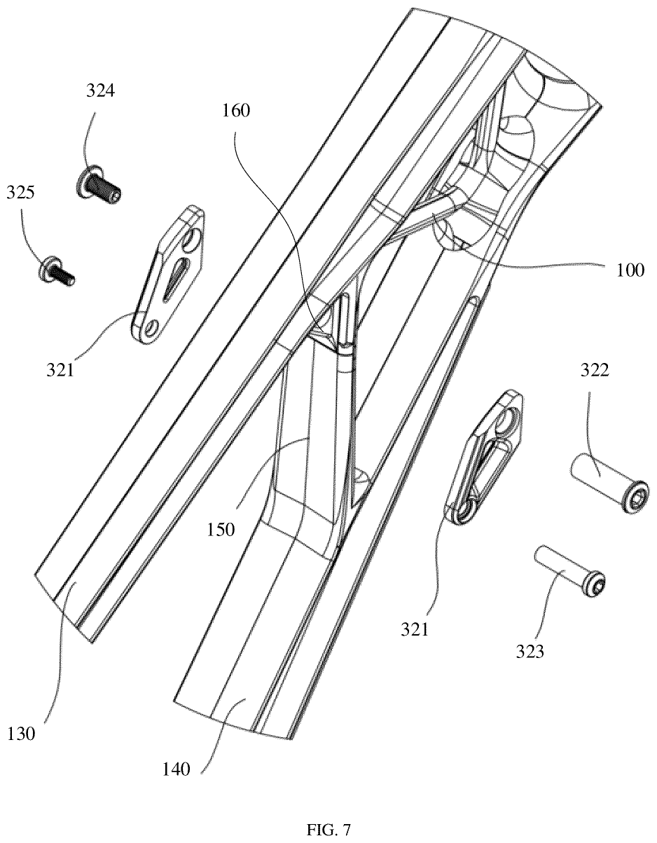

As shown in FIG. 6A and FIG. 6B, in some examples, the first support arm 130 and the second support arm 140 adopt an I-shaped cross-section, and the two can be collectively referred to as an I-beam, which has strong torsion resistance. The I-beam includes a web and flange plates located on both sides of the web, and a rounded transition portion can exist between the web and the flange plate to further improve the stability of the I-beam. In some application scenarios, the radius of the rounded transition portion can be set to not less than 7 mm.

In the cross-sectional view, the thickness and length of the web and the flange plate can be specifically designed according to the stress analysis, that is, unlike the traditional tubular structure, the I-beam can be more flexibly designed and modified in size. For example, the I-beam allows the thickness of the web or flange plate to be increased to more than 10 mm to strengthen the concentrated stress area, while the tubular structure of the transmission needs to be strengthened over the entire circumference, which leads to a significant increase in the weight of the entire front frame 100. Therefore, the ability of the I-beam to add material only when necessary enables the front frame 100 to maintain a specific strength-to-weight ratio, thereby providing advantages in terms of load-bearing capacity.

Based on the above shape design of the first bracket arm 130 and the second bracket arm 140, the casting production of the first bracket arm 130 and the second bracket arm 140 can be achieved by designing a mold, and the mold design can be modified according to production needs, so that the material for the casting application can be flexibly selected. This approach ensures that the overall frame of the first bracket arm 130 and the second bracket arm 140 can be accurately produced while maintaining structural integrity.

It can be seen that the I-beam or its equivalent structural design simplifies the manufacturing process of the front frame 100, enabling it to combine complex geometries and different wall thicknesses to meet the needs of stress-intensive applications. These cross-sectional shapes optimize the material distribution throughout the frame, address high stress areas, and minimize the overall weight of the front frame 100.

The open wall design of the I-beam or its equivalent structure allows for manufacturing using a three-axis CNC machine with a variety of clamping angle orientations. This configuration supports a variety of manufacturing processes, including die casting, which increases production speed and reduces manufacturing costs. The shape of the I-beam is easy to operate during the processing, and realizes precise cutting and adjustment that cannot be achieved in traditional closed tubular structures. Compatibility with die-casting can also achieve efficient mass production, reduce material waste, and simplify the overall manufacturing workflow.

In some embodiments, the I-beam section of the front frame can be configured with supportive structures like reinforcing rib 150. This design also accommodates various manufacturing processes, including die casting.

In some feasible embodiments, the front frame 100 can also be integrally cast.

In some application scenarios, the first bracket arm 130 or the second bracket arm 140 may need to provide nodes for the installation of other components. For example, the second bracket arm 140 may need to provide nodes for the installation of cranks, which may cause the second bracket arm 140 to have different cross-sections or thickness requirements at different positions. But in general, at least a portion of the arm segments in the first bracket arm 130 or the second bracket arm 140 can be designed as an I-shaped or H-shaped cross section. Based on this, in some embodiments, the first bracket arm 130 includes a first arm segment 131 with an I-shaped cross section, and the second bracket arm 140 includes a second arm segment 141 with an I-shaped cross section.

As shown in FIGS. 6A and 6B, in some embodiments, the cross-sectional area of the first arm segment 131 is smaller than the cross-sectional area of the second arm segment 141.

The first arm section 131 may be all or part of the first bracket arm 130, and the second arm section 141 may be all or part of the first bracket arm 130 of the second bracket arm 140. The first bracket arm 130 is located above the second bracket arm 140, which also makes the second arm section 141 bear greater stress than the first arm section 131. Designing the second arm section 141 to have a larger cross-sectional area than the first arm section 131 helps to ensure the reliability of the second arm section 141. At the same time, designing the first arm section 131 with a smaller cross-sectional area can also reduce the overall weight of the front frame 100.

As shown in FIGS. 6A and 6B, in some examples, the cross-sections of the first arm section 131 and the second arm section 141 can both be I-shaped, wherein the first arm section 131 includes a first web 1311, a first flange plate 1312, and a first rounded transition portion 1313; the second arm section 141 includes a second web 1411, a second flange plate 1412, and a second rounded transition portion 1413. In the cross-sectional view, by designing different web lengths or widths, or different flange lengths or widths, the cross-sectional areas of the first arm segment 131 and the second arm segment 141 can be different in size.

In some embodiments, the target part of the front frame 100, the first link 400 and the rear frame 200 are arranged in layers in the width direction of the suspension system, and the target part is the first bracket arm 130 and/or the second bracket arm 140.

As mentioned in the above embodiment, the front frame 100, the first link 400 and the rear frame 200 are pivotally connected, and the three can pivot relative to each other in one plane or multiple parallel planes, and the width direction of the suspension system usually corresponds to the direction perpendicular to these planes. For the convenience of explanation, the width direction of the suspension system can be referred to as the lateral direction.

In the lateral direction of the suspension system, the target part of the front frame 100, the first link 400 and the rear frame 200 are arranged in layers. When the three rotate relative to each other, one will not be blocked by the surface of the other parallel or substantially parallel to the lateral direction, that is, they are in a spatially open state in the rotation direction, thereby avoiding the collision of the three when the suspension system enters a compressed state, effectively improving the service life of the suspension system.

The front frame 100 is provided with a connection node for installing the shock absorber 310. In some embodiments, the shock absorber 310 can be directly connected to the front frame 100 by, for example, bolts, pins or snap structures. In other embodiments, in order to facilitate the flexible arrangement of the shock absorber 310 and meet the design requirements of the shock absorption performance parameters of the suspension system, the shock absorber 310 can also be indirectly connected to the front frame 100 by a shock absorption connection mechanism 320.

For example, in some embodiments, the suspension system further includes a shock absorption connection mechanism 320, and the first end of the shock absorber 310 is connected to the first connection node 101 through the shock absorption connection mechanism 320.

The shock-absorbing connection mechanism 320 may be an independent plate or rod, etc., and the two ends may be connected to the front frame 100 and the shock absorber 310 respectively by pivoting or fixing. In some examples, the first end of the shock-absorbing connection mechanism 320 may be fixedly connected to the front frame 100, and the second end may be pivotally connected to the shock absorber 310, or the first end of the shock-absorbing connection structure may be rotatably connected to the front frame 100, and the second end may be pivotally connected to the shock absorber 310. Or the two ends of the shock-absorbing connection structure may be fixedly connected to the front frame 100 and the shock absorber 310, etc. The design of the connection relationship in the shock-absorbing connection mechanism 320 is usually adapted to the motion requirements of other structures of the suspension structure to ensure that the relative motion path between the rear frame 200 and the front frame 100 is controllable.

In addition, by designing the parameters such as the length, shape or extension direction of the shock-absorbing connection mechanism 320, the orientation arrangement requirements of the shock absorber 310 can be flexibly met.

As shown in FIG. 7, in some embodiments, the shock-absorbing connection mechanism 320 includes: at least one connection plate 321, a first pin 322 and a second pin 323, wherein the first pin 322 is used to connect the first end of the connection plate 321 to the first connection node 101, and the second pin 323 is used to pivotally connect the second end of the connection plate 321 to the first end of the shock absorber 310.

This embodiment exemplarily provides a specific structure of the shock-absorbing connection mechanism 320, which can enable the shock-absorbing connection mechanism 320 to be easily assembled with the front frame 100 and the shock absorber 310.

In some embodiments, the first connection node 101 can be an opening reserved at a position on the front frame 100, and the first end of the connection plate 321 is reserved with a matching opening, and the first pin 322 is inserted into these openings to achieve the connection between the front frame 100 and the connection plate 321. A similar connection between the shock absorber 310 and the connection plate 321 can be achieved through the second pin 323.

The number of the connecting plates 321 may be one or more. For example, when the number of the connecting plates 321 is two, the two connecting plates 321 may be arranged on both sides of the first connecting node 101, respectively. The first pin 322 passes through the opening on the first connecting plate 321, the opening corresponding to the first connecting node 101, and the opening on the second connecting plate 321 in sequence to connect the connecting plates 321 and the front frame 100. It is easy to understand that the two connecting plates 321 can also be connected to the shock absorber 310 in a similar manner.

In some embodiments, the first pin 322 may have a cylindrical section and a tail portion with a cross section larger than the cylindrical section. The first screw may be used on the side of the cylindrical section away from the tail portion to form a structure with thick ends and thin middle, thereby being fixed relative to the front frame 100 in the axial direction. Similarly, the second pin 323 may also be used in conjunction with the second screw to achieve relative fixation with the front frame 100 in the axial direction.

In one embodiment, the front frame 100 includes a first bracket arm 130, a reinforcing rib 150 and a recessed platform 160. The recessed platform 160 is located at the angle between the first bracket arm 130 and the reinforcing rib 150. The first connection node 101 is provided on the recessed platform 160. The first end of the connecting plate 321 abuts against the inner wall of the first bracket arm 130 and the inner wall of the reinforcing rib 150 to limit the rotational freedom between the connecting plate 321 and the front frame 100.

In this embodiment, the front frame 100 may include a first bracket arm 130 and a reinforcing rib 150 arranged at an angle, and a recessed platform 160 is provided at the angle position. In the thickness direction of the front frame 100, the recessed platform 160 is recessed inwardly relative to the surface of the first bracket arm 130 and the reinforcing rib 150, so that an accommodation space is formed between the surface of the recessed platform 160, the inner wall of the first bracket arm 130 and the inner wall of the reinforcing rib 150, and the first end of the connecting plate 321 can be placed in the accommodation space.

The shape of the first end of the connecting plate 321 is substantially the same as the shape of the angle between the first bracket arm 130 and the reinforcing rib 150. In this way, when the connecting plate 321 is placed in the accommodation space, it can abut against the inner wall of the first bracket arm 130 and the inner wall of the reinforcing rib 150, and the rotational freedom of the connecting plate 321 relative to the front frame 100 is limited. In conjunction with the radial displacement restriction between the front frame 100 and the connecting plate 321 by the first pin 322, the front frame 100 and the connecting plate 321 may be in a roughly fixed connection relationship. At the same time, the setting of the recessed platform 160 can also prevent the connecting plate 321 from protruding too much to the outside, thereby improving the smoothness of the overall appearance.

In some embodiments, the rear frame 200 further includes a rear wheel mounting portion 240 and a third support arm 210, a fourth support arm 220 and a fifth support arm 230 connected in a triangular shape, the third connection node 201 is located at the connection between the third support arm 210 and the fourth support arm 220, the fourth connection node 202 is located at the connection between the fourth support arm 220 and the fifth support arm 230, and the rear wheel mounting portion 240 is located at the connection between the third support arm 210 and the fifth support arm 230.

In this embodiment, the shape of the rear frame 200 is a triangle or an approximate triangle design, so that the rear frame 200 has a high structural reliability. Based on the triangular design, the rear frame 200 can be divided into a third support arm 210, a fourth support arm 220 and a fifth support arm 230, which correspond to the three sides of the triangle respectively.

In some examples, the support arms included in the rear frame 200 can be fixed by welding, bolting, etc. For example, each support arm can adopt a tubular structure and form an integral structure by welding, etc. Alternatively, the various support arms included in the rear frame 200 may also be integrally connected. For example, the rear frame 200 may also adopt an I-shaped cross section similar to the front frame 100, so that the rear frame 200 can be integrally cast.

The material of the rear frame 200 may be similar to that of the front frame 100. For example, in some examples, the rear frame 200 may be made of one or more of aluminum alloy, magnesium alloy, steel alloy, polymer material and carbon fiber composite material.

The rear frame 200 includes some nodes or mounting parts for connecting with other components, such as a third connection node 201 for connecting with the shock absorber 310, a fourth connection node 202 for connecting with the first connecting rod 400, and a rear wheel mounting part 240 for mounting the rear wheel and its related accessories. These connection nodes or mounting parts may be distributed at the position where the two support arms meet, so as to reduce the influence of the opening and other structures on the overall strength of the rear frame 200.

In some embodiments, the rear frame 200 may also include a structure for facilitating the assembly of other parts of the bicycle. For example, as shown in FIG. 1 and FIG. 2, the rear frame 200 also includes an extension frame 250 disposed on the third support arm 210 for installing the rear wheel brake mechanism. Of course, the specific structure of the rear frame 200 can be designed according to the assembly requirements of other bicycle functional parts, which will not be described in detail here.

The absolute length or relative length between the third support arm 210, the fourth support arm 220 and the fifth support arm 230 can be designed according to the performance parameter requirements of the suspension system. In some examples, the lengths of the third support arm 210, the fourth support arm 220 and the fifth support arm 230 can be reduced in sequence. Of course, this relative length relationship can also be adjusted according to design requirements.

In the embodiment of the present disclosure, the design of the length, shape, etc. of the first connecting rod 400 has an important influence on optimizing the stress distribution in the first connecting rod 400, the relative motion path between the front frame 100 and the rear frame 200, and the overall performance of the suspension system.

In one embodiment, the first link 400 includes a third arm segment 410 and a fourth arm segment 420, the third arm segment 410 is pivotally connected to the fourth connection node 202 and extends approximately along the length direction of the fifth bracket arm 230, and the fourth arm segment 420 is connected to the second connection node 102 and arranged at an angle to the third arm segment 410.

Combined with the description of the working principle of the suspension system in the above embodiment, when a bicycle using the suspension system is traveling in a complex terrain, the rear wheel may encounter an obstacle or similar situation, and the rear wheel is subjected to force and transmitted to the rear frame 200. The rear frame 200 is constrained by the first link 400 and transmits the force to the shock absorber 310, or indirectly transmits the force to the shock absorber 310 through the second connection, so that the shock absorber 310 is compressed and completes the shock absorption movement. In this process, the constraint ability of the first link 400 on the rear frame 200 has an important influence on the transmission effect of the external impact force to the shock absorber 310. The force transmission direction of the rear frame 200 to the first link 400 is usually roughly along the direction of the fifth bracket arm 230. In this embodiment, the first link 400 is divided into a third arm section 410 and a fourth arm section 420 arranged at an angle, and the length direction of the third arm section 410 is designed to be roughly the same as the length direction of the fifth bracket arm 230, which can improve the restraint ability of the first link 400 to the rear frame 200.

In some examples, a balanced transition can be made between the third arm section 410 and the fourth arm section 420 to optimize the stress distribution in the first link 400. In some feasible embodiments, the first link 400 can also extend in a straight line as a whole.

The material and cross-sectional shape of the first link 400 can be designed according to actual needs, and the embodiment of the present disclosure does not specifically limit this.

The suspension system provided in some embodiments of the present disclosure includes the first link 400, and the design of the size or shape of the first link 400 additionally provides a way to achieve the performance parameters of the suspension system. In some application scenarios, the design of the size, shape and connection relationship of the front frame 100, the rear frame 200, the first link 400 and other components can enable the suspension system or the bicycle including the suspension system to obtain the desired performance parameters.

Various embodiments of the present disclosure also provide a vehicle or a pedal cycle such as a bicycle including the above suspension system.

Some optional embodiments of the bicycle and the corresponding technical effects can refer to the description of the suspension system above, and no repeated description is given here.

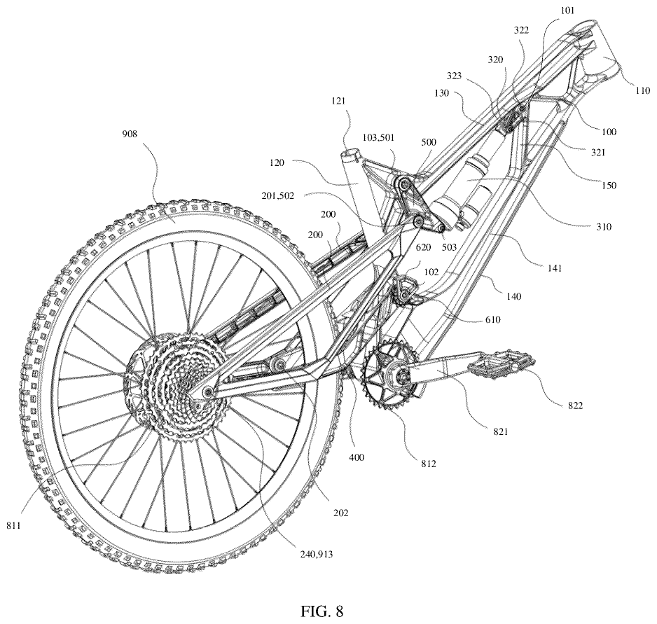

As shown in FIG. 8, in some embodiments, the bicycle may also include other components. For example, a transmission system, the transmission system may include a chain or an equivalent connecting rod, a gear set, a derailleur or an equivalent, a crank 821, etc. Among them, the number of gear sets may be multiple, and these gear sets may have the same or different chain ring radii, a support structure compatible with the chain, etc. In some examples, the multiple gear sets may include a rear gear set 811, a crank gear set 812, etc., and the number of gears in each gear set may be one or more. It is worth noting that in some embodiments, the gears in the gear set can be equivalently described as sprockets, etc.

In addition, a pedal 822 may be provided on the crank 821. On the rear wheel mounting portion 240 of the rear frame 200, a rear axle 913 and a rear wheel 908 can be mounted. On the additional accessory mounting portion 110 of the front frame 100, a front fork and related structures can be mounted.

In some embodiments of the present disclosure, based on the design of the suspension system, transmission system and other structures, the bicycle can obtain the desired performance parameters. Generally speaking, the performance parameters of a bicycle may include chain growth, wheel travel, undamped natural frequency, chainline-IC offset, anti-squat, anti-rise, leverage ratio, pedal rebound, magnified axle path, etc. The following examples illustrate the meaning of some performance parameters and the design requirements of the suspension system for these performance parameters.

Anti-squat is the reaction of the suspension system to the movement of the pedal 822. When pedaling 822, the anti-squat resistance absorbs most of the force of the rear frame 200. A system with 100% anti-squat means that there is no compression or extension of the suspension system during the application of pedal force. Values exceeding 100% of the target parameter will cause the suspension system to extend, and values below the specified parameter will have a compression effect.

The anti-squat value of a bicycle is calculated based on the relationship between the bicycle's suspension system geometry, drive train forces, and the weight distribution of the rider. Engineering the suspension system to maintain a consistent anti-squat value throughout the travel range can optimize pedaling efficiency.

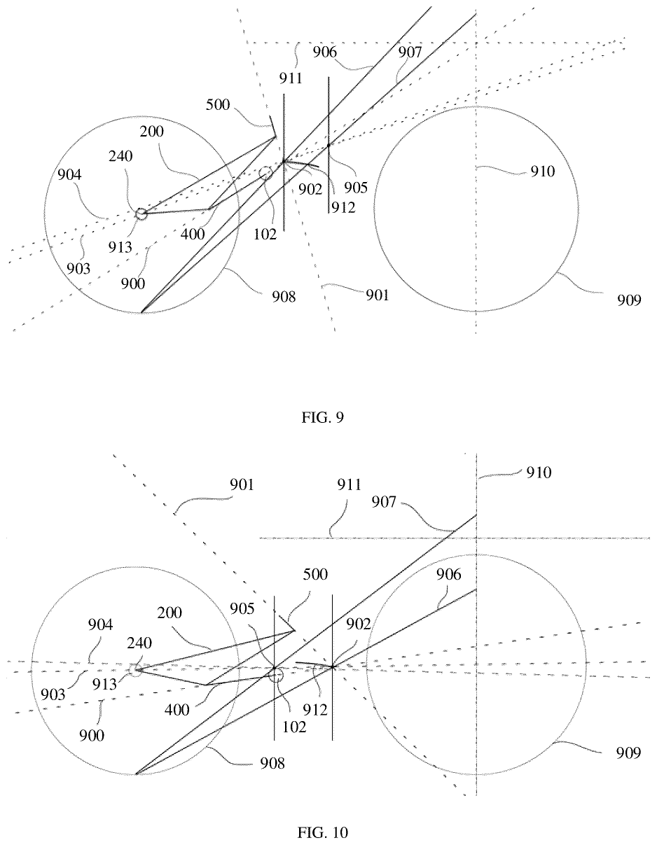

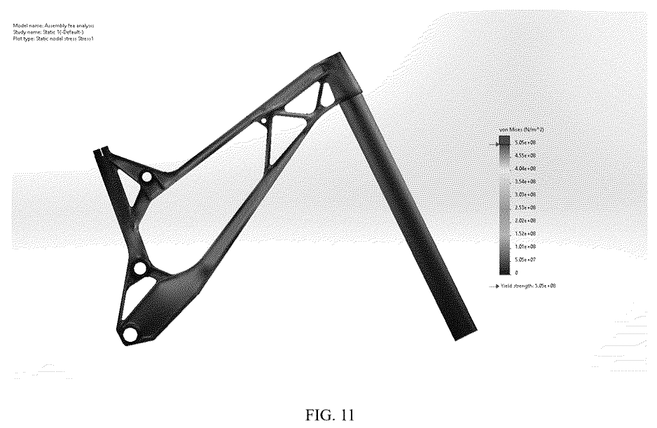

As shown in FIGS. 9 and 10, in order to evaluate the anti-squat value, the suspension system utilizes two key link auxiliary lines. The lower link auxiliary line 900 is established by connecting the fourth connection node 202 to the second connection node 102 and extending it. At the same time, the upper link auxiliary line 901 is established by connecting the third connection node 201 to the first connection node 101 and extending it. These lines are infinitely extended, and their intersection defines the instantaneous center (IC) 902, which is a key reference point for evaluating the behavior of the suspension system.

The axle auxiliary line 903 is constructed by connecting the rear axle 913 (corresponding to the rear wheel mounting portion 240) to the IC 902. In addition, the extension line of the upper chain line 904 is included, and the intersection between the axle auxiliary line 903 and the extension line of the upper chain line 904 is recorded as ICas 905. Then, the anti-squat line 907 is drawn from the bottom of the rear wheel to the ICas 905 and extended to intersect with the vertical projection 910 of the bottom of the front wheel 909. The height of this intersection is designated as H2. The height of the center of gravity of the ride system is designated as H1. The percentage is calculated using the following formula:

Anti-squat value (%)=(H2/H1)×100.

A horizontal auxiliary line 911 is drawn through the center of gravity of the ride system, and the intersection with the vertical projection 910 of the bottom of the front wheel 909 is 100% anti-squat value.

Anti-rise characteristics are also evaluated similarly. An auxiliary line 906 is drawn from the bottom of the rear wheel 908 to the IC 902. The intersection of this auxiliary line 906 with the vertical projection 910 of the bottom of the front wheel 909 defines a height H3. The anti-rise value percentage is calculated using the following equation:

Anti-rise value (%)=(H3/H1)×100.

In some embodiments of the present disclosure, by setting a specific ratio between the lengths of the first link 400, the second link 500, and the rear frame 200 segment connecting them, this determines the behavior of the IC 902 along the IC path 912. When the suspension is compressed, the lower link auxiliary line 900 rotates in a clockwise direction, while the second link 500 rotates counterclockwise. This causes the IC 902 to gradually move to the right and downward. When the system is compressed, the upper chain line 904 rotates clockwise, which would normally increase the anti-squat value if the IC 902 remained stationary. Various embodiments of the present disclosure can ensure that the IC path 912 counteracts this tendency and maintains a stable anti-squat graphic value line throughout the stroke. This consistent anti-squat behavior improves pedaling efficiency by minimizing power loss during acceleration and providing better control on different terrains.

In some specific embodiments, the performance parameters of the bicycle can be configured according to at least one of the following requirements.

IC maximum offset requirement: By configuring the transmission system, the net maximum difference in offset between the highest IC and the lowest IC of the bicycle is less than a first preset value, in some examples. The first preset value can be 15 mm.

Anti-uplift range requirement: The anti-uplift requirement of the suspension system is limited to a preset value range. In some examples, the preset value range can be 80%˜135%.

Anti-squat value tolerance requirement: When the wheel travel is 0, the bicycle has an initial anti-squat value. The difference between the actual anti-squat value of the bicycle under various state lines and the initial anti-squat value, and the ratio of the initial anti-squat value to the initial anti-squat value is less than the second preset value. In some examples, the second preset value may be 5%.

Chain stroke change requirement: The chain may refer to the chain located at the top of the chain transmission system, such as the chain between the idler body 610 and the rear gear set. Of course, the chain may also be other equivalent connecting rods. The chain stroke change requirement may be that the chain or equivalent connecting rod extends negatively throughout the entire stroke.

Anti-rebound requirement: Referring to the description of the above embodiment, under the environment of external impact, the chain or equivalent connecting rod may exert force on the link, etc., thereby causing crank reversal and pedal rebound. The anti-rebound requirement may refer to the angle of crank reversal or pedal rebound being lower than the third preset value. In some examples, the third preset value may be 0.05°.

Vibration frequency requirement: The initial value of the vibration frequency of the suspension system is lower than the fourth preset value, and the vibration frequency at the maximum wheel travel is lower than the fifth preset value. In some examples, the fourth preset value may be 1.4 Hz, and the fifth preset value may be 1.8 Hz.

Leverage ratio requirement: The rate of change of the leverage ratio of the suspension system in the first half of the wheel travel is lower than the rate of change of the leverage ratio in the second half of the wheel travel. That is, in a curve with the wheel travel as the independent variable and the leverage ratio as the dependent variable, the slope of the curve increases as the wheel travel increases.

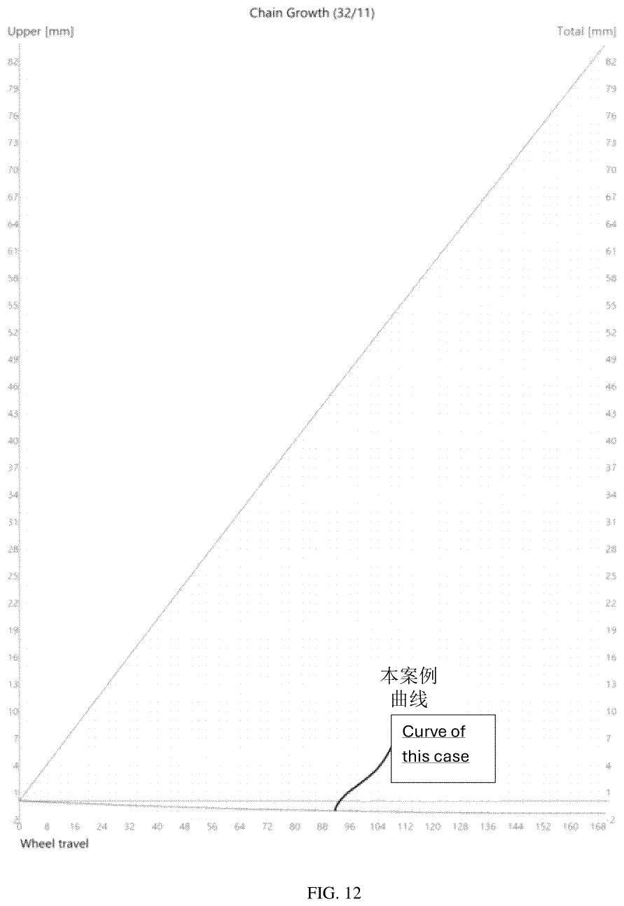

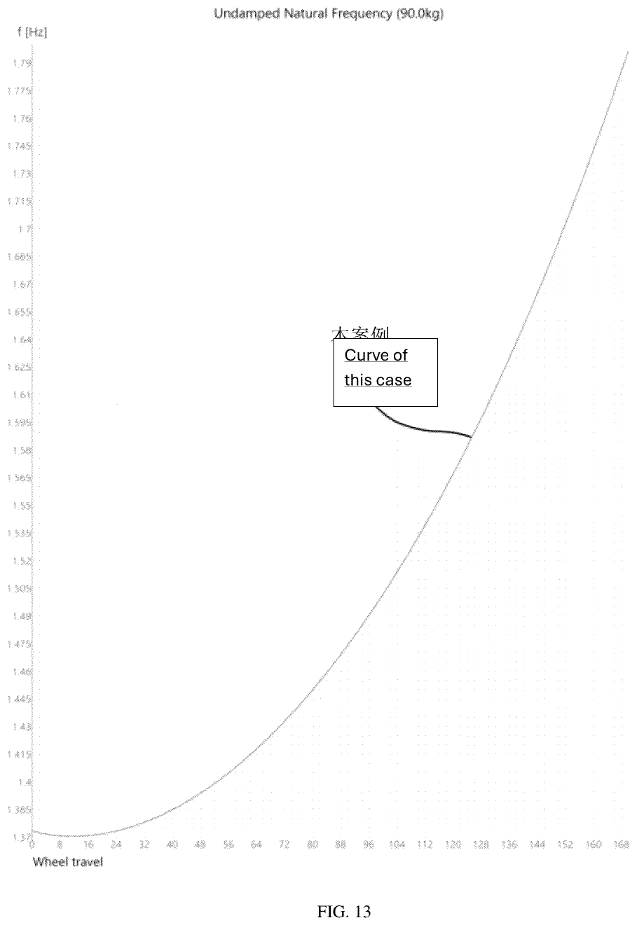

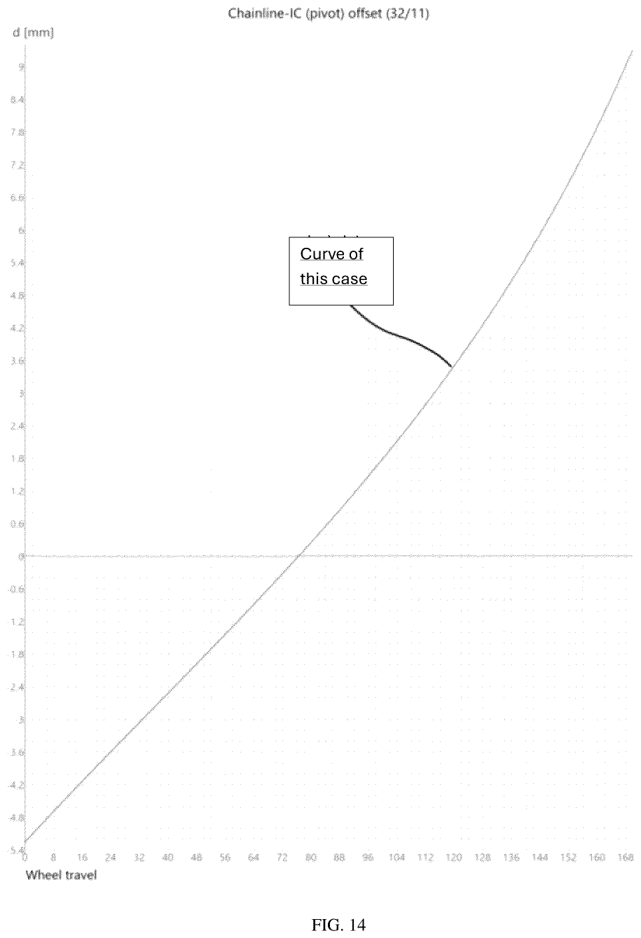

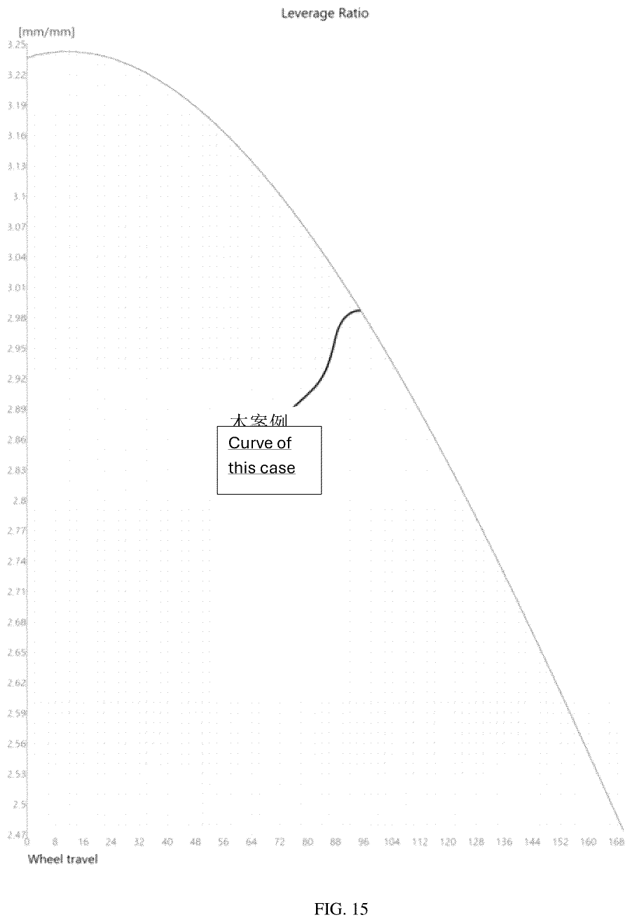

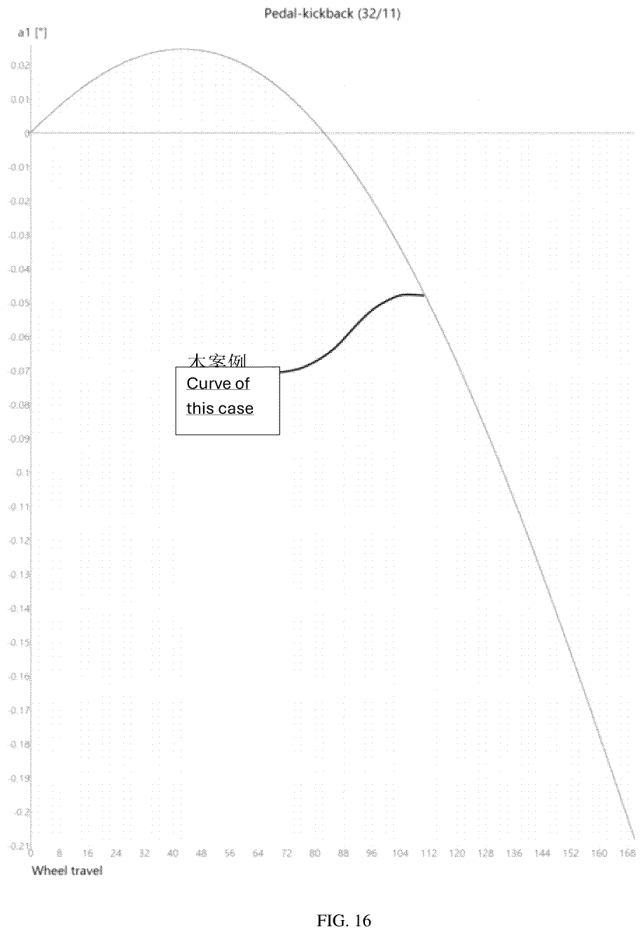

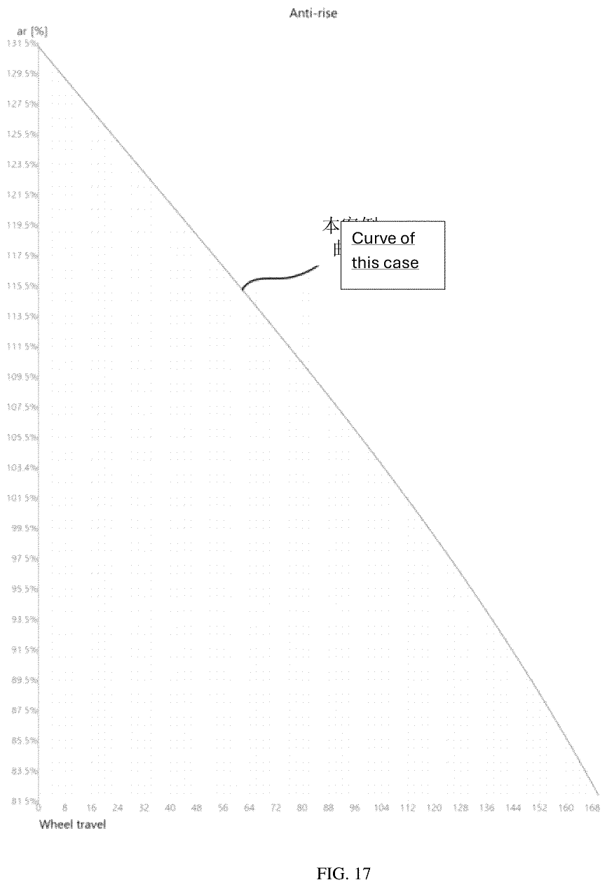

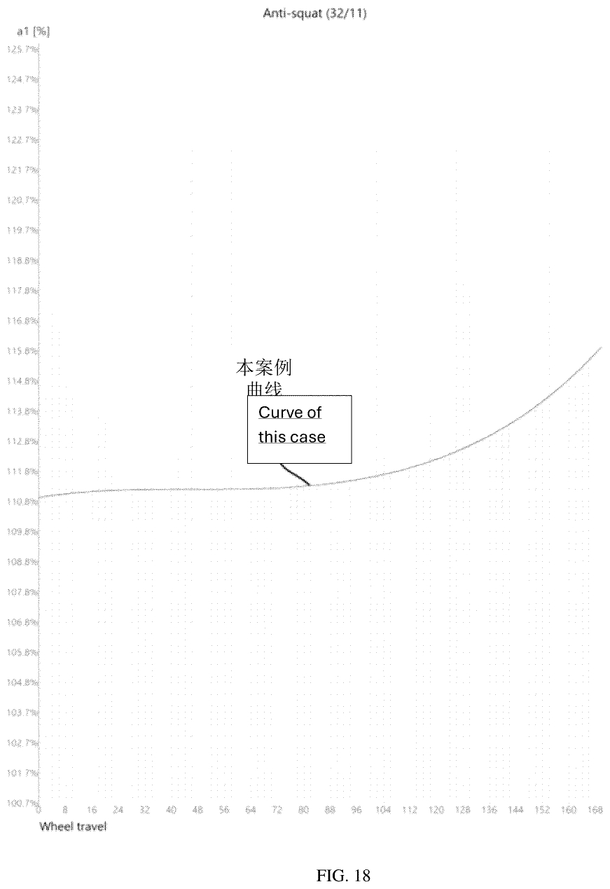

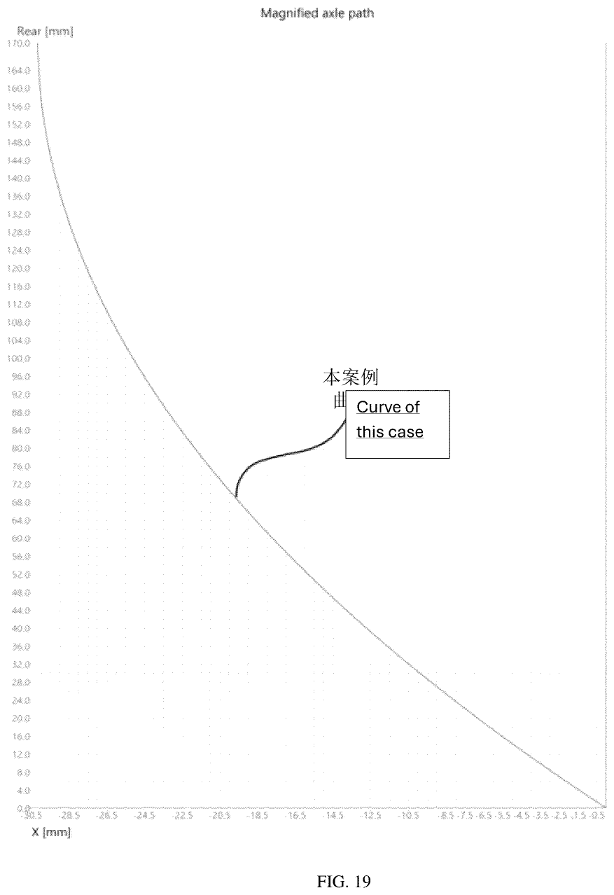

As shown in FIG. 11, FIG. 11 is a schematic diagram of the appearance and stress simulation of the suspension system in a specific application case. FIG. 12 to FIG. 19 are curves of some performance parameters of the suspension system and a bicycle using the suspension system. It can be seen that based on the structure of the suspension system in the present disclosure, the design requirements of the strength and other performance parameters of the bicycle can be basically met.

In the description of this specification, the description of the reference terms “one embodiment”, “some embodiments”, “illustrative embodiments”, “examples”, “specific examples”, or “some examples” means that the specific features, structures, materials or characteristics described in combination with the embodiment or example are included in at least one embodiment or example of the present disclosure. In this specification, the schematic representation of the above terms does not necessarily refer to the same embodiment or example. Moreover, the specific features, structures, materials or characteristics described may be combined in any one or more embodiments or examples in a suitable manner.

Although the embodiments of the present disclosure have been shown and described, a person skilled in the art will understand that various changes, modifications, substitutions and variations may be made to these embodiments without departing from the principles and purposes of the present disclosure, and the scope of the present disclosure is defined by the claims and their equivalents.

What is claimed is:

1. A suspension system, comprising:
a front frame comprising a first connection node and a second connection node;
a rear frame comprising a third connection node and a fourth connection node;
a shock absorber, having a first end connected to the first connection node at a pin location, and a second end connected to the third connection node;
a first connecting rod having two ends respectively pivotally connected to the second connection node and the fourth connection node, the first connecting rod being at least configured to provide the front frame and the rear frame with relative displacement in a front-rear direction.

2. The suspension system according to claim 1, further comprising a second connecting rod, wherein
the second connecting rod comprises a fifth connecting node, a sixth connecting node and a seventh connecting node, and
the front frame further comprises an eighth connecting node;
the fifth connecting node is pivotally connected to the eighth connecting node, the sixth connecting node is pivotally connected to the third connecting node, and the seventh connecting node is pivotally connected to the second end of the shock absorber; and
the fifth connecting node, the sixth connecting node and the seventh connecting node are distributed in a triangle.

3. The suspension system according to claim 2, wherein
a first straight line length from the fifth connection node to the sixth connection node is less than a second straight line length from the fifth connection node to the seventh connection node; and
a third straight line length between the second connection node and the fourth connection node is greater than or equal to 200 mm, and a fourth straight line length between the fifth connection node and the sixth connection node is less than or equal to 50% of the third straight line length.

4. The suspension system according to claim 1, further comprising an idler mechanism connected to the front frame.

5. The suspension system according to claim 4, wherein the front frame further comprises a crank mounting portion, wherein
the crank mounting portion and the idler mechanism are relatively fixed in position, and
when the suspension system is standing on a horizontal plane, the crank mounting portion is located below the idler mechanism.

6. The suspension system according to claim 4, wherein
the rear frame further comprises a rear wheel mounting portion, and
when the shock absorber is in a released state and the suspension system is standing on a horizontal plane, the rear wheel mounting portion is located below the idler mechanism.

7. The suspension system according to claim 4, wherein the idler mechanism comprises:
an idler body rotatably coupled to the front frame; and
a chain stabilizer straddled on the idler body and enclosed with the idler body to form a limiting space.

8. The suspension system according to claim 7, wherein the idler mechanism further comprises a pin having a first end embedded in the axial end opening of the target pivot shaft, the chain stabilizer being limited in the axial direction of the pin between the second end of the pin and the axial end of the target pivot shaft, the target pivot shaft being a pivot shaft for pivoting the second connection node and the first connecting rod;
a first bearing, the first bearing being used for rotatably connecting the idler body to the pin;
a bearing retainer, the bearing retainer being used for limiting the relative movement between the first bearing and the chain stabilizer in the axial direction.

9. The suspension system according to claim 1, wherein the front frame comprises:
an additional accessory mounting portion;
a central tube;
a first bracket arm having a first end fixedly coupled to the additional accessory mounting portion, and a second end fixedly coupled to the central tube; and
a second bracket arm having a first end fixedly coupled to the additional accessory mounting portion, and a second end fixedly coupled to the central tube,
wherein the second bracket arm is located below the first bracket arm.

10. The suspension system according to claim 9, wherein the front frame further comprises a reinforcing rib, the reinforcing rib being located on a side close to the additional accessory mounting portion, and the reinforcing rib, the first bracket arm and the second bracket arm enclose at least one hollow area.

11. The suspension system according to claim 9, wherein the first bracket arm comprises a first arm segment having an I-shaped cross section, and the second bracket arm comprises a second arm segment having an I-shaped cross section.

12. The suspension system according to claim 11, wherein the first bracket arm and the second bracket arm are integrally cast.

13. The suspension system according to claim 11, wherein the target part of the front frame, the first link and the rear frame are arranged in layers in the width direction of the suspension system, and the target part is the first bracket arm and/or the second bracket arm.

14. The suspension system according to claim 10, further comprising a shock absorbing connection mechanism having a first end coupled to the first connection node through the shock absorbing connection mechanism.

15. The suspension system according to claim 14, wherein the shock absorbing connection mechanism comprises:
at least one connection plate;
a first pin configured to connect the first end of the connection plate to the first connection node;
a second pin configured to pivotally connect the second end of the connection plate to the first end of the shock absorber.

16. The suspension system according to claim 15, wherein
the front frame comprises a first support arm, a reinforcing rib and a recessed platform, the recessed platform is located at the angle between the first support arm and the reinforcing rib, and the first connection node is provided on the recessed platform; and
the first end of the connecting plate abuts against the inner wall of the first support arm and the inner wall of the reinforcing rib to limit the rotational freedom between the connecting plate and the front frame.

17. The suspension system according to claim 1, wherein the rear frame further comprises a rear wheel mounting portion and a third support arm, a fourth support arm and a fifth support arm connected in a triangle, the third connection node is located at the connection between the third support arm and the fourth support arm, the fourth connection node is located at the connection between the fourth support arm and the fifth support arm, and the rear wheel mounting portion is located at the connection between the third support arm and the fifth support arm.

18. The suspension system according to claim 17, wherein the first link comprises:
a third arm segment, the third arm segment being pivotally connected to the fourth connection node and extending substantially along the length direction of the fifth bracket arm; and
a fourth arm segment, the fourth arm segment being connected to the second connection node and arranged at an angle to the third arm segment;
wherein a direct distance of the node on the first link is greater than a distance between the rear axle and the node.

19. A pedal cycle comprising the suspension system according claim 1.

20. The pedal cycle according to claim 19, wherein the pedal cycle is a mountain bicycle.
